(19) United States
(12) Patent Application Publication
(10) Pub. No.: US 2006/0126950 A1
(43) Pub. Date: Jun. 15, 2006

(54) Method for managing image files in mobile communication terminal

(75) Inventors: Jin Chul Ahn, Seongnam (KR); Sung Soo Lee, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: PANTECH & CURITEL COMMUNICATIONS, INC.

(21) Appl. No.: 11/302,874

(22) Filed: Dec. 14, 2005

(30) Foreign Application Priority Data
Dec. 14, 2004 (KR) 10-2004-0105451

(51) Int. Cl. G06K 9/36

(52) U.S. Cl. 382/232

(57) ABSTRACT

Disclosed is a method for managing image files in a mobile communication terminal capable of classifying a compressed image file in each field unit and then restructuring the compressed image file only with a field including essential information among the classified fields, thereby storing and managing the files. The method comprises processes of retrieves a compressed image file, which is produced in itself in the mobile communication terminal or received via the communication process, in a byte unit, classifying it in each field unit, and extracting only field information which is essential information to restructure the compressed image file. Thereby, the mobile communication terminal stores and manages the compressed image file restructured only with the essential information in the internal memory, and increasing an overall efficiency of the terminal memory and decreasing a possibility of an error occurrence during the decoding operation and the image acquisition operation for the compressed image file.

### CROSS-REFERENCE TO RELATED APPLICATION

The present application is claiming priority of Korean Patent Application No. 10-2004-0105451 filed on Dec. 14, 2004, the content of which is herein incorporated by reference.

### BACKGROUND OF THE INVENTION

1. Field of the Invention

The present invention relates to a method for managing image files in a mobile communication terminal capable of classifying a compressed image file in each field unit and then restructuring the compressed image file only with a field including essential information among the classified fields, thereafter storing and managing the files.

2. Description of the Prior Art

As image processing and communication technologies are developed, a standards organizations such as ITU-T or ISO has suggested some image data compression standards such as jointed photographic experts group (JPEG) or moving picture experts group (MPEG).

In addition, in recent years, a mobile communication terminal (cellular phone, PCS, PDA, vehicle phone, etc.) has been developed to have a high-sensitivity part and a more light-weight and a size thereof has been gradually miniaturized. Further, to meet the needs of customers, it has been developed a mobile communication terminal having a variety of additional functions, for example a multi-media communication, a wireless internet communication, a camera function and the like.

The mobile communication terminal can produce image data (e.g., JPEG image) through taking a photograph in itself or download compressed image data via a wireless internet communication, computer or other communication terminals using the multi-media communication or wireless internet communication function. The compressed image file (for example, JPEG image file (JPG file)) downloaded to the mobile communication terminal includes additional information in an Application field and an Extension field defined in an image compression related standard as the JPEG standard. The additional information includes a program having produced a corresponding image file, a file production time and the like. Due to the additional information, a size of the image file is increased.

In other words, the mobile communication terminal according to the prior art stores and manages a compressed image file including a variety of additional information and data related to the compressed image as it is in an internal memory, in addition to image data which is actually used in the terminal. Namely, unnecessary additional information and data occupy the memory region, thereby decreasing an overall memory efficiency of the mobile communication terminal. In addition, due to the unnecessary additional information and data, it is increased a possibility of an error occurrence when performing a decoding operation and an image information acquisition operation for the image file.

### SUMMARY OF THE INVENTION

Accordingly, the present invention has been made to solve the above problems. An object of the invention is to provide a method for managing image files in a mobile communication terminal capable of retrieving a compressed image File produced in itself in the mobile communication terminal or received via a communication process in a byte unit, classifying the image file in each field unit, and extracting only field information which is essential information, thereafter restructuring the compressed image file.

Another object of the invention is to provide a method for managing image files in a mobile communication terminal capable of allowing only a compressed image file restructured only with essential information having unnecessary information or data removed therefrom to be stored and managed in an internal memory of a mobile communication terminal having a limited storage capacity of the internal memory, thereby increasing an overall efficiency of the terminal memory and decreasing a possibility of an error occurrence when performing a decoding operation and an image information acquisition operation for the compressed image file.

In order to achieve the above object, there is provided a method for managing image files in a mobile communication terminal comprising processes of: classifying a compressed image file in each field unit in the mobile communication terminal; extracting field information which is essential information from fields constituting the classified compressed image file to restructure the compressed image file; and storing and managing the restructured compressed image file in an internal memory of the mobile communication terminal.

Preferably, the process of classifying the compressed image file in each field unit may comprise a process of retrieving the compressed image file in a byte unit.

In addition, the process of classifying the compressed image file in each field unit may comprise a process of checking a marker dividing each field and field size information.

Preferably, the compressed image file may be classified into an Image body field including actual image information and other fields.

In addition, the other fields except the Image body field may comprise at least one of an Extension field including correction/editing information of the compressed image file; an Application field including program information having produced the compressed image file; and a Redundancy field including thumbnail information added by the mobile communication terminal so as to provide a preview function regarding the compressed image file.

Preferably, the process of restructuring the compressed image file may comprise a process of providing the Image body field as essential information of the compressed image file to be restructured, and selectively providing the Extension field, the Application field and the Redundancy field.

Preferably, a range of the field selectively provided except the Image body field when restructuring the compressed image file may be determined by checking how much is an unused storage capacity of the internal memory of the mobile communication terminal.

Alternatively, a range of the field selectively provided except the Image body field when restructuring the compressed image file may be determined depending on a user's choice of the mobile communication terminal.

Preferably, some information of the Extension field, the Application field and the Redundancy field may be extracted to provide it to the compressed image file to be restructured, in addition to the image body file when restructuring the compressed image file.

### BRIEF DESCRIPTION OF THE DRAWINGS

The above and other objects, features and advantages of the present invention will be more apparent from the following detailed description taken in conjunction with the accompanying drawing, in which:

FIG. 1 is a flow chart for explaining an operation for managing image files in a mobile communication terminal according to an embodiment of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

In the present invention, when storing and managing a compressed image file in a mobile communication terminal, the compressed image file is retrieved in a byte unit to remove, store and manage additional information or data unnecessary from a viewpoint of the terminal. Thereby, it is possible to increase an overall memory efficiency of the mobile communication terminal and to decrease a possibility of an error occurrence at the same time. The image file managing operation may be controlled by a mobile station modem (MSM) chipset, for example.

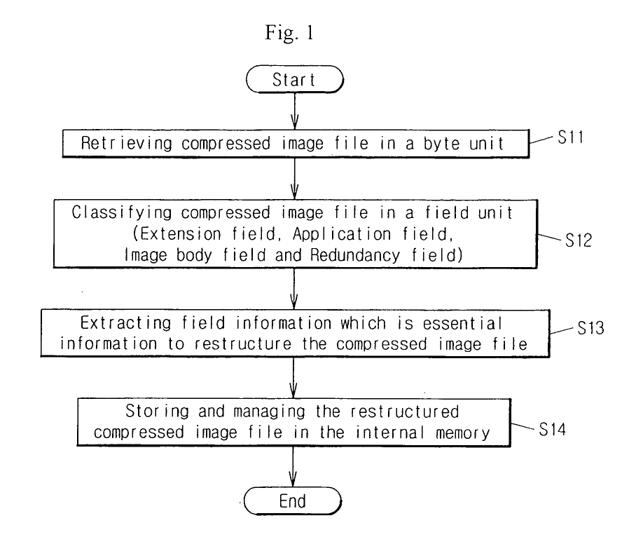

Hereinafter, an image file managing operation of a mobile communication terminal according to the invention will be described with reference to FIG. 1.

First, when a mobile communication terminal produces a compressed image file in itself through a photographing using a camera sensor or receives a compressed image file via a series of communication processes, a MSM chipset corresponding to a central processing section of the terminal retrieves the compressed image file produced in itself or received (S11).

In case that the image file is received via the communication process, the MSM chipset retrieves the file in a byte unit to check a marker attached to a header of the file so as to determine whether the file is a compressed image file or not. If it is determined that the received image file is a compressed image file, the MSM chipset retrieves the compressed image file in a byte unit.

To the contrary, in case that the image file is produced in itself by the mobile communication terminal, since the MSM chipset has already known that the image file is a compressed image file, the MSM chipset immediately retrieves the compressed image file after producing the compressed image file.

Then, the MSM chipset retrieves the compressed image file in a byte unit to classify the compressed image file in a field unit. In this case, the compressed image file can be classified into an Image body field including actual image information and other fields (S12). In this case, the other fields except the Image body field can be again classified into an Extension field, an Application field and a Redundancy field. The Extension field, Application field and Redundancy field may be present in the compressed image file or not, in character of the compressed image file.

After that, the MSM chipset extracts field information, which is essential information for storing and managing the compressed image file in the terminal, from the fields constituting the classified compressed image file to restructure the compressed image file (S13).

The MSM chipset stores and manages the restructured compressed image file in an internal memory of the terminal (S14). The body image file which is actual image information is essentially included in the restructured compressed image file. The other fields may be included in the restructured compressed image file together with additional information produced depending on a necessity in the mobile communication terminal.

In addition, the other fields except the Image body field, i.e., the Extension field, the Application field and the Redundancy field are selectively included in the restructured compressed image file or some information of the fields are extracted and then included in the restructured compressed image file as additional information.

More specifically, the MSM chipset retrieves compressed image file in a byte unit so as to classify the compressed image file in a field unit, and checks a marker dividing each of the fields and field size information, thereby classifying the compressed image file into the extension, application, image body, Redundancy fields.

In other words, when the MSM chipset detects a marker indicating a start of the Extension field during the retrieval of the compressed image file in a byte unit, it checks field size information (Extension field size information) next to the marker, thereby classifying data having a corresponding size as Extension field. Likewise, when the MSM chipset detects a marker indicating the Application field during the retrieval of the compressed image file in a byte unit, it checks field size information of the field next to the marker, thereby classifying data having a corresponding size as an Application field.

In addition, when the MSM chipset detects a marker indicating a start of the Image body field, it continuously retrieves the compressed image file in a byte unit until a marker indicating an end of the corresponding Image body field is detected, thereby classifying the corresponding image body file. The MSM chipset classifies the data after the marker indicating the end of the Image body field as a Redundancy field.

The Extension field is a field in which a thumbnail image and additional information are included depending on the necessities of the compressed image file or additional information about correction/editing is included when the image file is corrected/edited in the computer and the like. Since the information about the Extension field is not essential information when storing and managing the compressed image file in the mobile communication terminal, it may be structured that the information is selectively included in the compressed image file to be restructured.

The Application field is a field in which a thumbnail image or other additional information, i.e., program information having produced the compressed image file, production date and the like are included. Since the information is not essential information when storing and managing the compressed image file in the mobile communication terminal, it may be structured that the information is selectively included in the compressed image file to be restructured.

In addition, the Redundancy field is a field in which a thumbnail image added by the mobile communication terminal so as to provide a preview function for the compressed image file, a RGB image or information which is not defined in a standard is included. Since the information of the Redundancy field is not essential information when storing and managing the compressed image file in the mobile communication terminal, it may be structured that the information is selectively included in the compressed image file to be restructured.

As describe above, according to the invention, the compressed image file, which is produced in itself in the mobile communication terminal or received via the communication process, is retrieved in a byte unit and classified in each field unit. Then, the field information which is essential information is extracted to restructure the compressed image file. Accordingly, it is possible to store and manage the compressed image file in the internal memory, which file is restructured only with the essential information having the additional information or data unnecessary from the viewpoint of the mobile communication terminal removed therefrom.

In addition, according to the invention, the compressed image file restructured only with the field information which is essential information in the mobile communication terminal is stored and managed in the internal memory, so that it is possible to increase the overall efficiency of the terminal memory and to minimize a possibility of an error occurrence during the decoding operation and the image information acquisition operation for the compressed image file.

While the invention has been shown and described with reference to certain preferred embodiments thereof, it will be understood by those skilled in the art that various alternatives, modifications and changes in form and details may be made thereto without departing from the spirit and scope of the invention as defined by the appended claims. For example, when the MSM chipset of the mobile communication terminal classifies the compressed image file in each field unit to restructure the compressed image file only with the field information which is essential information, the range of the field, which is essential information included in the compressed image file to be restructured, may be determined by checking how much is an unused storage capacity of the internal memory of the mobile communication terminal, or depending on a user's choice of the mobile communication terminal.

What is claimed is:

1. A method for managing image files in a mobile communication terminal comprising processes of:
classifying a compressed image file in each field unit in the mobile communication terminal;
extracting field information which is essential information from fields constituting the classified compressed image file to restructure the compressed image file; and
storing the restructured compressed image file in an internal memory of the mobile communication terminal.

2. The method according to claim 1, wherein the process of classifying the compressed image file in each field unit comprises a process of retrieving the compressed image file in a byte unit.

3. The method according to claim 1, wherein the process of classifying the compressed image file in each field unit comprises a process of checking a marker dividing each field and field size information.

4. The method according to claim 1, wherein the compressed image file is classified into an Image body field including actual image information and other fields.

5. The method according to claim 4, wherein the other fields except the Image body field comprise at least one of an Extension field including correction/editing information of the compressed image file; an Application field including program information having produced the compressed image file; and a Redundancy field including thumbnail information added by the mobile communication terminal so as to provide a preview function regarding the compressed image file.

6. The method according to claim 5, wherein the process of restructuring the compressed image file comprises a process of providing the image body field as essential information of the compressed image file to be restructured, and selectively providing the Extension field, the Application field and the Redundancy field.

7. The method according to claim 6, wherein a range of the field selectively provided except the Image body field when restructuring the compressed image file is determined by checking how much is an unused storage capacity of the internal memory of the mobile communication terminal.

8. The method according to claim 6, wherein a range of the field selectively provided except the Image body field when restructuring the compressed image file is determined depending on a user's choice of the mobile communication terminal.

9. The method according to claim 6, wherein some information of the Extension field, the Application field and the Redundancy field is extracted to provide it to the compressed image file to be restructured, in addition to the image body file when restructuring the compressed image file.
